(19) United States
(12) Patent Application Publication
(10) Pub. No.: US 2020/0388447 A1
(43) Pub. Date: Dec. 10, 2020

(54) AN ELECTRICAL SWITCH AND A SWITCHING BLADE THEREFOR

(71) Applicant: INTROL IP LIMITED, Hamilton (NZ)

(72) Inventor: Andrew Joseph PALMER, Hamilton (NZ)

(21) Appl. No.: 16/625,086

(22) PCT Filed: Jun. 21, 2018
(86) PCT No.: PCT/NZ2018/050086

§ 371 Date: Dec. 20, 2019

(30) Foreign Application Priority Data
Jun. 21, 2017 (NZ) 732824
Sep. 14, 2017 (NZ) 735331

(51) Int. Cl. H01H 5/02; H01H 5/18; H01H 1/26

(52) U.S. Cl. CPC H01H 5/02; H01H 5/18; H01H 2201/026; H01H 2201/024; H01H 1/26

(57) ABSTRACT

Energy regulators which use a bi-metallic strip to open and close electrical contacts are commonly used in household appliances for temperature regulation. This approach however often results in a slow connection and disconnection of the electrical contacts. This can result in arcing which can reduce the life of the switching components and/or cause the contacts to bond together which poses a potential safety risk. Disclosed is a switching blade suitable for use in an energy regulator in which the electrical contacts are connected and disconnected rapidly. Also described is an improvement to the construction of the switching blade whereby the movement of the blade may provide an impact or jolt to separate contacts which may have bonded together.

### STATEMENT OF CORRESPONDING APPLICATIONS

This application is based on the Provisional specifications filed in relation to New Zealand Patent Application Numbers 732,824 and 735,331 the entire contents of which are incorporated herein by reference.

### TECHNICAL FIELD

The present invention relates to an electrical switch. The invention has particular application to the switching blade of the electrical switch.

### BACKGROUND ART

There are two ways in which current through an electrical circuit can be controlled, these being either mechanical involving switches, or electronic, involving transistors or the like.

A mechanical switch is effectively any mechanism that allows two conducting elements to touch each other thereby forming an electrical connection. The two parts of the conductive elements that touch each other are referred to as contacts. When the contacts are touching each other, the switch is said to be closed and an electrical current is flowing. When the switch is open, the contacts are not touching and no electrical current can flow.

When using contacts, it is desirable that the electrical current is initiated or ceased as quickly as possible. This is because a rapid closure or opening of the switch, and therefore corresponding movement of the contacts, reduces the possibility of arcing. Arcing is undesirable as it can have a detrimental impact on the overall life of the switch.

This also reduces the risk of the contacts overheating, which in a worst case scenario can result in the bonding of contacts. This would cause contacts to become fixed to each other and thus potentially allowing electrical currents to flow when not intended. This can have serious implications for safety. There is also less radio interference should the flow of electrical current cease as quickly as possible. Such radio interference can affect electromagnetic circuits.

One desirable characteristic of a switch incorporating contacts is a good “snap action”. This is when there is a fast separation (or joining, as the case may be) of the contacts. This minimises any arcing that may occur. Sometimes this can be achieved through a fast actuation method; the natural speed and force of the actuator is sufficient to achieve good snap action.

However, in some instances, it is desirable to have a slow actuation method. Appliances, such as stoves which use slower actuation methods for regulating temperature of cooking elements, often utilise actuators in the form of bimetals. These are strips of layered metals, where at least one layer is a different metal to the other layers. When these are heated up, one layer deforms at a greater rate than the other and gradually applies force to one of the contacts until it reaches a point where it “snaps” open. This breaks the electrical circuit.

In these slower actuation methods, what are known as switching blades are used. One such example is described in U.S. Pat. No. 3,110,789, which is used in a temperature switch.

When the contacts are in a closed position, a magnetically permeable moving blade sandwiches a switching blade against a magnet. A contact on the switching blade touches another contact in the switch to maintain an electrical current. A bimetal component is linked to the moving blade.

This bimetal component heats up, and due to the differing rates of expansion of the two metals forming this component, gradually bears against the moving blade. The increasing force reaches a point where it is sufficient to break the magnetic force of the magnet, pulling the switching blade away from the magnet as well, thereby stopping the electrical current.

However, while this switching blade works reasonably well, it is still a relatively complex arrangement with a number of components, these being a bimetallic actuator, a magnetically permeable blade, as well as the switching blade itself.

There are alternative configurations for slow acting switching blades, and an example arranged as an over-centre spring is described in U.S. Pat. No. 5,696,479. This switching blade, which is inherently sprung, acts upon a contact arm to apply a biasing force. When sufficient force is applied, contact is broken with good snap action.

However, due to inbuilt stresses required to achieve the desired snap action, these types of blades are made from relatively expensive materials, such as copper titanium or beryllium copper. These materials are able retain their stresses for an extended period of time without compromising their action and in a variety of environments. Consequently, it is costly to both manufacture and assemble switches incorporating these types of switching blades.

An alternative arrangement is desirable and would be advantageous. Therefore, it is an object of the present invention to address the foregoing problems. At the very least, the present invention provides the public with a useful choice.

All references, including any patents or patent applications that may be cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Further aspects and advantages of the present invention will become apparent from the ensuing description which is given by way of example only.

### DISCLOSURE OF THE INVENTION

According to one aspect of the present invention there is provided a switching blade for an electrical switch, the switching blade including:

a surround, wherein the surround includes a cutout defined by an inner perimeter;

a blade having an attached end and a head, wherein the head extends into the cutout;

characterised in that

wherein the head of the blade is displaced from the surround in a direction perpendicular to a main plane of the surround and wherein the inner perimeter of the cutout includes a shoulder with a contact surface for the head of the blade, and wherein the attached end of the blade is integral with the inner perimeter.

According to one aspect of the present invention there is provided an electrical switch, wherein the electrical switch includes a switching blade having:

a surround, wherein the surround includes a cutout defined by an inner perimeter;

a blade having an attached end and a head, wherein the head extends into the cutout;

characterised in that

wherein the head of the blade is displaced from the surround in a direction perpendicular to a main plane of the surround and wherein the inner perimeter of the cutout includes a shoulder with a contact surface for the head of the blade, and wherein the attached end of the blade is integral with the inner perimeter.

According to another aspect of the present invention there is provided a method of manufacturing a switching blade for an electrical switch, the switching blade substantially as described above wherein a method includes the steps of:
a) forming the switching blade from a blank sheet of metal;
b) creating a cutout in the switching blade to define a blade and a surround;
c) deforming a portion of the blade to displace the head of the blade relative to the surround.

According to a yet further aspect of the present invention, there is provided a switching blade for an electrical switch, the switching blade including:

a surround; and

a blade, wherein the blade is at least partially attached to the surround, and wherein the blade is configured to move relative to the surround,

further wherein the movement of the blade relative to the surround is limited in at least one direction by an interfering member.

According to a yet further aspect of the present invention there is provided a method of manufacturing a switching blade for an electrical switch, the method including the steps of:
a) forming the switching blade from a blank sheet of metal;
b) creating a cutout in the switching blade to define a blade and a surround;
c) forming an interfering member in the switching blade to limit the travel of the blade relative to the surround.

The invention is a switching blade and should be referred to as such throughout the remainder of the specification.

The switching blade may be used with any mechanical electrical switch that may incorporate an actuator. It should be appreciated that the switching blade may be used with many different types of actuators including, but not limited to, bi-metallic conductors (responsive to temperatures) and electromagnetic actuators.

The switching blade should be understood to be formed from a single flat sheet metal blank using conventional metal stamping and pressing techniques. Not only does this mean that the manufacture of the switching blade is relatively straightforward compared to the more complex arrangements of the prior art, it also reduces the number of components required to assemble the switching blade.

The metal from which the blank is formed should be understood to be sprung metal, and could be plated metal or stainless steel, copper, brass or a similar electrically conductive alloy or the like.

In some embodiments of the invention, the blank may be entirely or partially formed from INVAR (or FeNi) which is an alloy of nickel and iron and has a very low coefficient of thermal expansion. INVAR loses magnetic attraction when heated to a sufficient temperature. This can be convenient in the event that a bi-metallic conductor is not being used as the actuator. In other embodiments, a permanent magnet may be attached to the blank.

INVAR may also be known as INVAR 36 (or FeNi36 or 64FeNi in the US), an alloy which comprises approximately 36% Nickel, and 64% Iron. However other metallic alloys may be used, and this example should not be seen as limiting on the scope of the invention.

As will become apparent from the following discussion, a portion of the switching blade is movable, hence the importance of the blank being formed from a sprung metal. This allows the moveable portion of the switching blade to temporarily deform in response to an application of force. So long as the force is not too high such that the deformation becomes permanent, the moveable portion can return to its original position upon removal of that force.

In one application, a first contact is mounted on the moveable portion of the blade and a second contact is mounted in a fixed location relative to the switching blade. In this application, the use of sprung metal also means that it is possible to apply a force to the switching blade, placing it under tension, before the contacts are opened. This means that there is a good “snap action” in that the electrical circuit is quickly opened with minimal arcing.

A further advantage of the present invention is that it allows the use of lower grade sprung metals than is typically used at present. This has a subsequent impact on cost of manufacture as there is no need to use specialised (and expensive) sprung metal.

In exemplary embodiments of the invention the blank is substantially rectangular or square in plan view. However, it is possible that the blank may take another shape depending on the electrical switch, and its housing, with which the switching blade is to be used.

It should be understood that the blank, before being stamped or pressed, is substantially flat and all parts of the blank, including those that form the cutout, blade, and any flanges are all substantially in the same plane.

In some embodiments of the invention, during stamping and pressing, a portion of the blank may be formed with a combination of flanges and/or cutouts that when appropriately folded define a compartment or recess configured to receive a magnet.

During the manufacturing process of the switching blade, a cutout, which should be understood to mean an opening, is created substantially at or proximate the centre of the blank. It should be appreciated that the placement of the cutout may vary depending on the final configuration of the switching blade.

The switching blade should be understood to have an outer perimeter, which defines the extreme edges of the switching blade and an inner perimeter, which defines the cutout.

The portion of the blank between the inner and outer perimeter, or at least a substantial part of this portion, forms the surround of the switching blade.

In a preferred embodiment, the surround is substantially fixed in use, and the blade moves to open and close the electrical contacts. In an alternative embodiment the surround of the switching blade moves along with the blade in order to assist with the opening and or closing of the electrical contacts.

In some embodiments, the surround may be formed with flanges or the like. These can assist in the assembly of the electrical switch incorporating the switching blade by providing a mounting surface complementary to structures within the switch. These flanges may also be formed to provide the interfering member(s).

The blank, once formed, includes a tab extending into the cutout. This tab should be understood to be the blade of the switching blade and shall be referred to as such throughout the remainder of this specification.

As the blank is formed from sprung metal, the blade is able to deform upon application of a force or energy and is thus a moveable portion of the switching blade.

The blade has a free end which should be understood to be the head. The other end is connected to the inner perimeter of the surround. It will be appreciated that this means that the head has the greatest range of motion when deformed.

In exemplary embodiments of the invention, the end of the blade is configured with an aperture or similar means to allow a contact. The contact may be constructed from copper, a silver coated dome or any suitable electrical conductor known to those skilled in the art. This contact may be affixed through the use of conventional riveting or welding techniques. In use, this contact will conduct current to a nearby electrical contact with which the switching blade is to be used.

In exemplary embodiments of the invention, a portion of the blade is configured as a head with an upper face and a lower face.

In exemplary embodiments of the invention, it is the lower face that bears the contact in use. However, some embodiments of the blade may bear the contact on the upper face.

A neck leads from the head to the inner perimeter of the surround. In exemplary embodiments, the head has a width greater than that of the neck and thus is relatively distinguishable from the neck. However, in some embodiments the neck of the blade may be substantially indistinguishable from the head of the blade. In other words, the neck of the blade may have substantially the same width as the head.

During the manufacture of the switching blade, a portion of the neck is folded or bent through the use of conventional metal stamping techniques. This has the effect of pulling the head of the blade towards the inner perimeter of the surround and displacing it in a direction perpendicular to the main plane of the surround.

In an alternative embodiment, the surround may be folded or bent to create a similar displacement between the head of the blade and the surround.

In a preferred embodiment, a portion of the inner perimeter of the surround is configured an interfering member in the form of shoulders. This provides a potential contact surface between the surround and the upper or lower face of the head of the blade which is important for the function of the invention. In an alternative embodiment, apertures may be formed in the surround which are configured as interfering members.

It will be understood, that the term “shoulders” as used throughout this specification should be taken to mean any form of interfering member which limits the travel of the blade relative to the surround in at least one direction. These shoulders may be provided by the deformation of the surround during stamping/forming or otherwise be provided by a separate component.

Contact between the head of the blade and the interfering member (shoulder) may be achieved in a number of ways. In a first example, contact could be made (once the neck has been bent or folded as noted above) should the head be sufficiently biased towards the shoulders. Alternatively, a portion of the surround, including the inner perimeter, may be deformed such that the shoulders be sufficiently biased towards, and touches, the head of the blade. In a yet further embodiment, the interfering members are provided by apertures in flanges on the surround, and the deformation of the flanges is configured to align the head of the blade with said apertures.

This biasing is caused through the application of a force to either the head (or neck) of the blade or to the portion of the surround about the head. This force may be provided by an actuator, the type of which will depend on the end use of the electrical switch with which the switching blade of the present invention is to be used.

For example, a bimetal, upon being reheated, may gradually deform and apply force to the head of the blade until it reaches a temperature sufficient to cause displacement of the head such that it contacts the shoulders of the surround. The blade, being formed from sprung metal, is naturally inclined to spring open. In embodiments in which a permanent magnet is present, this provides a constant closing force which the bimetal will need to overcome.

The force applied to the shoulders by the head can gradually increase until it is removed. This then potentially accelerates the opening of the circuit with minimal arcing. Alternatively, the bimetal may be arranged to apply a force to a portion of the surround, urging the shoulders of same towards the head until contact is made.

The present invention offers a number of advantages over the prior art including:
easy to manufacture by virtue of being a one-piece component;
provides good “snap action” by virtue of creating an initial acceleration of the blade before it is contacted, thereby causing a sudden opening/closing of the contacts;
inexpensive to manufacture;
has a wide range of applications including, but not limited to, temperature switches, energy regulators and relays;
at the very least, the present invention provides the public with a useful choice.

### BRIEF DESCRIPTION OF DRAWINGS

Further aspects of the present invention will become apparent from the following description which is given by way of example only and with reference to the accompanying drawings in which:

FIG. 1A is a perspective view of an exemplary embodiment of the present invention;

FIG. 1B is a plan view of the embodiment of FIG. 1A;

FIG. 2 is a plan view of the blank from which the embodiment of FIGS. 1A and 1B is formed;

FIG. 3A is a perspective view of an alternative exemplary embodiment of the present invention;

FIG. 3B is a side view of the embodiment of FIG. 3A;

FIG. 4A is a perspective view of a yet further exemplary embodiment of the present invention;

FIG. 4B is a side view of the switching blade of FIG. 4A in-use in an energy regulator; and

FIG. 5 is an underside view of a yet further embodiment of a switching blade of the present invention.

### BEST MODES FOR CARRYING OUT THE INVENTION

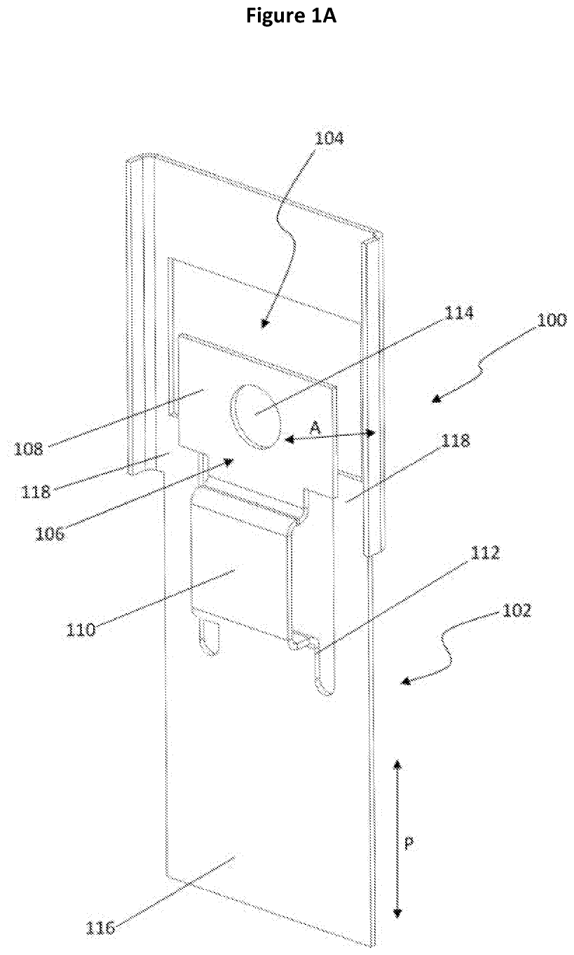

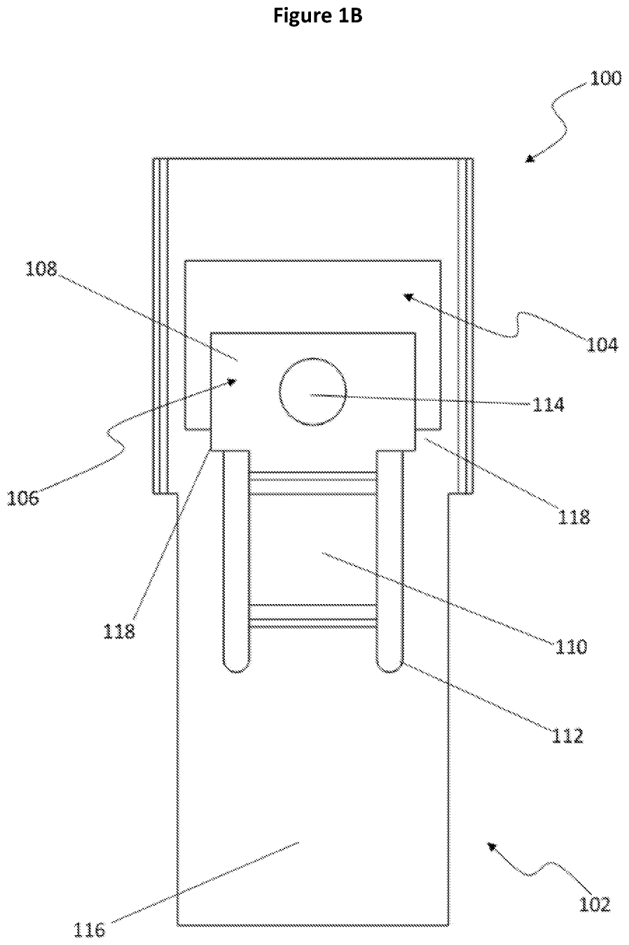

One embodiment of the switching blade of the present invention is shown in FIGS. 1A and 1B. These figures show the switching blade (identified as 100) as a unitary structure formed from a single sheet of sprung metal.

The switching blade includes a surround (102), which is the main portion of the switching blade and, disposed within a cut out (104) of the surround, a blade (106).

In this embodiment, the blade (106) has a defined, rectangular shape, head (108). A neck portion (110) links the blade to the inner perimeter (112) of the surround (102).

In use, a contact in the form of a silver coated dome or the like (not shown), would be fixed or otherwise engaged with the aperture (114) at the centre of the head. This serves as the electrical contact of the switching blade (100) and in use, engages with the contact of the switch (not shown).

An important aspect of the invention (100) is the displacement of the head (108) in a direction (arrow A) perpendicular to the main plane (P) of the surround. This is achieved through a deformation of the neck portion (110) such that it is kinked. This allows some independent movement of the head relative to the surround (102) which is important to the operation of the invention.

One end (116) of the surround (102) is anchored or otherwise fixed within the switch (not shown) in which the switching blade (100) is to be used. However, it should be appreciated that, as the switching blade is made of a sprung metal, the remainder of the surround is capable of some deformation. This is also important to the operation of the invention.

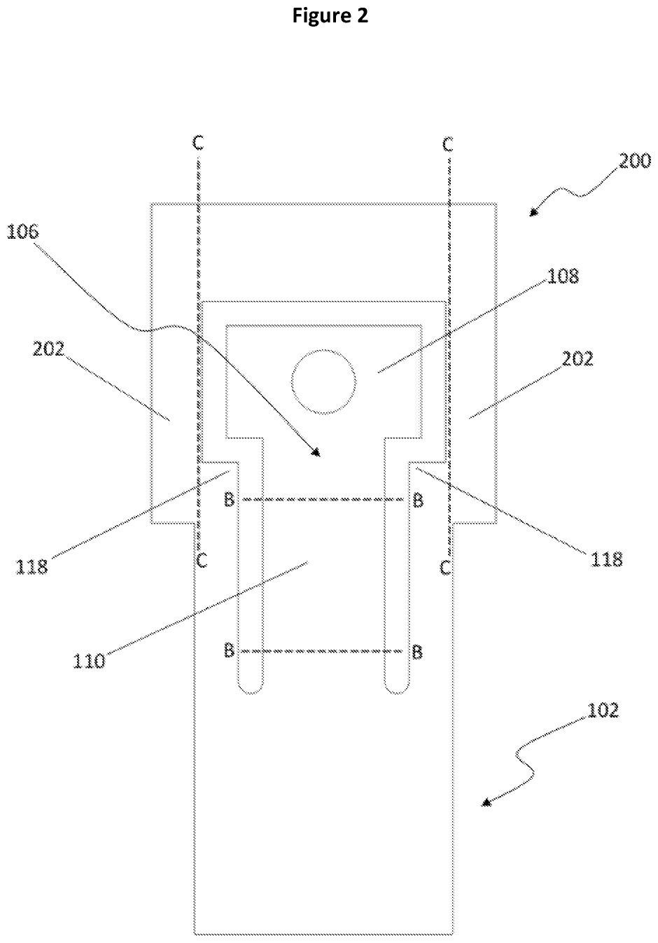

Turning now to FIG. 2, this shows the blank (200) from which the switching blade of FIGS. 1A and 1B is formed. The blank shown has a preformed cut out (104), aperture (114) and profiled outer shape, however this should not be seen as limiting on the invention, and these features may be formed by any processes known to those skilled in the art such as punching or stamping.

Being substantially flat, the blade (106) and its head (108) lie in the same plane as the surround (102). Dashed lines B indicate approximate fold lines at points along the neck (110). Likewise, the structures (202) that would form flanges upon being bent along the dashed lines indicated by C are in the same plane as the surround.

During the manufacturing process, the neck portion (110) is stamped to deform it along dashed lines B. The flanges (202) likewise are folded to the vertical about dashed lines C during this process.

The effect of this deformation of the neck (110) is that, as shown when shown in plan view, as per FIG. 1B, parts of the head (106) overlap a portion of the surround (102). This portion should be understood to be the interfering member(s) or shoulders (118) of the surround.

However as will apparent from FIG. 1A, there is still some lateral distance between the head (108) and the shoulders (118). In use, the contact (not shown) on the head conducts current through to a complementary contact (not shown) within the switch. To close the contacts to allow flow of current, a force is applied to the blade (102) by an actuator. This force deforms the blade so that it bends and closes the gap between the contacts until they touch. This continues so that the head of the blade effectively springs back compared to the surround (102). This places a load on the contacts. When opening the contacts upon sufficient application of force such that the shoulders (118) contact the head (108), this breaks (also referred to as opens) the electrical circuit, preventing flow of electrical current.

The gap between the shoulders (118) and head (108) allows the shoulders to build up momentum and speed, while the contacts (not shown) are still contacting each other. This means that when the shoulders meet the head, the contacts are snapped open relatively quickly, with limited opportunity for any arcing or the like.

Furthermore, with the contact (not shown) being mounted to what effectively is a spring (in the form of the blade (106)), there may be reduced contact bounce on closing, which is undesirable.

The force may be applied to the blade (106) in a number of different ways, depending on the actuator and the application of electrical switch (not shown) with which the switching blade (100) is to be used.

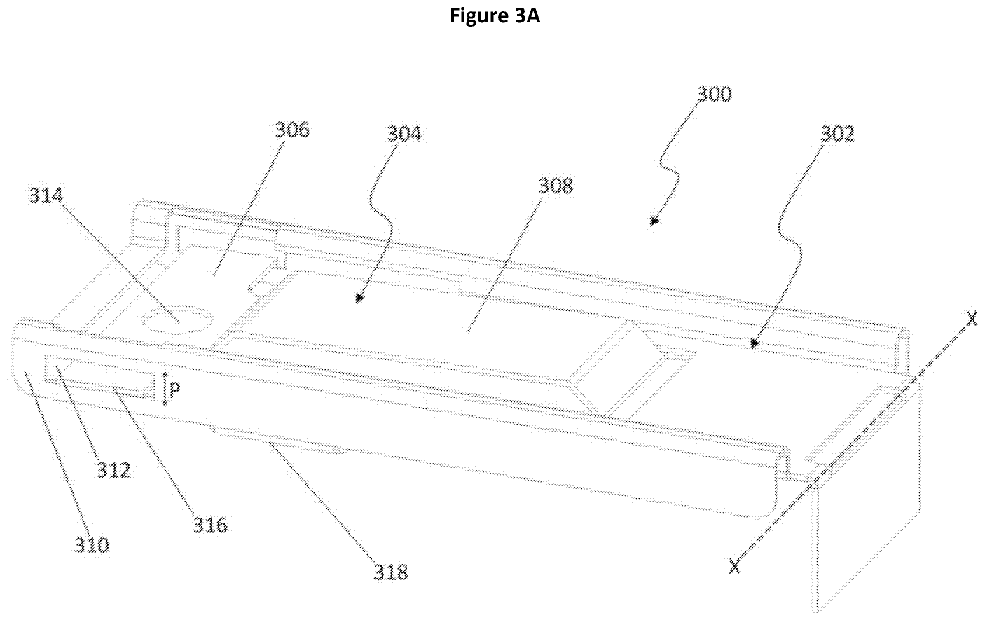

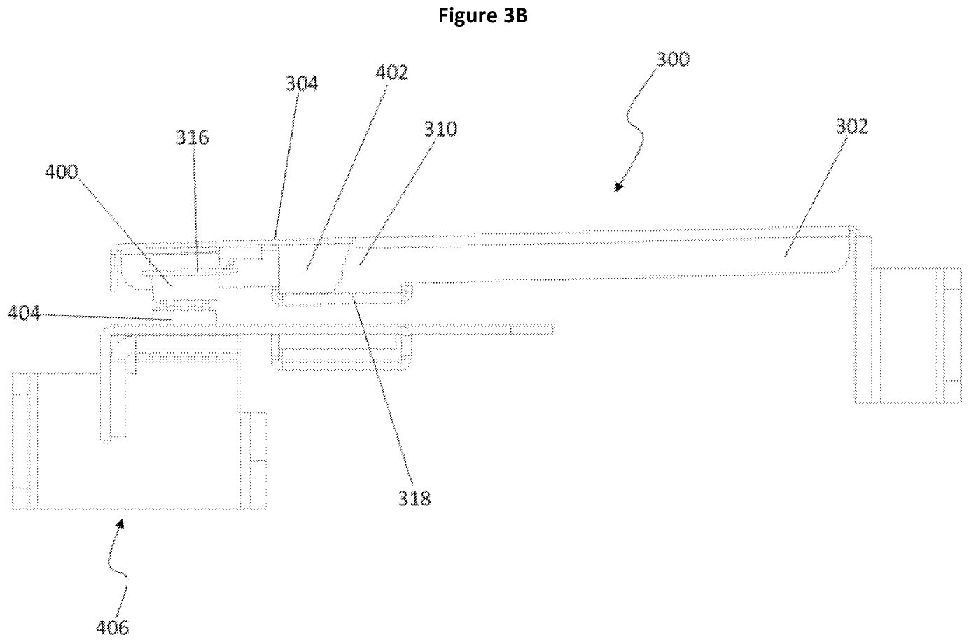

An alternative embodiment of the invention (300) is depicted in FIG. 3A. This is a slightly more complex arrangement than the embodiment of FIGS. 1A, 1B, and 2, but still includes a surround (302) and a blade (304) with a head (306) and neck portion (308). However, in this embodiment, the flanges (310) of the surround are configured with a slot (312) through which the extreme side edges (316) of the head extend. In this configuration the slot (312) provides the interfering member which limits the movement of the blade relative to the surround.

The depth of the slot (312) in the vertical plane (P) determines the range of movement of the head (306) in both a forward and backward direction. This is ideal for use with magnets or a magnetically permeable material. It can also provide a relatively strict control of the switching action itself for greater accuracy. In an alternative embodiment the slot may be replaced by a channel configured to limit the movement of the head of the blade in a single direction only.

In the embodiment depicted in FIG. 3A the head (306) is biased downwardly towards the lower edge of the slot (312). In this configuration, the surround is able to travel a further distance (P) once the electrical contacts have mated. Conversely, when breaking (opening) the electrical contacts, the surround is able to move independently of the blade for a distance (P) and therefore acquire some momentum before the interfering member/slot (312) engages the lower face of the head of the blade resulting in a rapid opening of the electrical contacts.

In an alternative embodiment, the head (306) may be biased upwardly towards the upper edge of the slot (312). In this configuration, when the contacts are opening, the blade will tend to move with the surround, however should there be any sticking of the contacts (potentially due to spot welding) then the surround will continue to move independently of the blade until the head contacts the lower edge of the slot causing a hammer action/shock/impulse which breaks the connection between the contacts.

In a yet further alternative, when the switching blade is in a rest position, that is to say when the contacts are open, the head (306) of the blade may be positioned in an intermediate position between the upper and lower edges of the slot (312). This configuration may provide both of the advantages outlined above albeit with a reduced travel distance, which is likely to result in a reduced momentum/lower force impact between the head and the slot.

The magnet (not shown in this view) may be held in a compartment (318) on the underside of the blade (304). This magnet is used to attract the blade, its head (306) and the surround (302) together in a forward direction, overcoming the natural sprung bias of the blade so that its contact (only aperture 314 into which the contact would be fitted is shown) closes with that of the switch (not shown) to allow electrical current to flow.

The blade (302) continues to move forward a limited amount even after the contacts (not shown) close due to the slot (312) allowing a set amount of independent movement before the tabs on the head (316) touch the bottom of the slot stopping any further movement and applying all forces then into the opposing contact (not shown). The movement within the slot leading up to full close then helps to reduce contact bounce as previously described.

To open, the force used to close the contacts (not shown) applied to the surround (302) can be reduced which, depending on the actuation method could be gradually or quickly, until the opening force (supplied by the sprung bias of the blade 302 toward opening) overcomes the closing force, at that time the surround starts to accelerate backward. This movement of the surround is about axis X.

During this movement, the contacts (not shown) remain closed due to the slot (312) and the preload previously applied on closing. The movement continues until the surround (302) uses up the range of movement provided by the slot such that the side edges (316) of the head (306) bears against the top of the slot. This impact snaps the contacts apart with a hammer like blow providing fast contact break.

FIG. 3B shows a side view of the embodiment (300) of FIG. 3 with the contacts (400) of the blade (304) present, mounted to the lower face of the head. It should be appreciated that flange (310) has been partially cut away in this view and this exposes the magnet (402) within its compartment (318). Also present is the opposing contact (404) of the switch (406). As can be seen, the contacts are in a closed condition, allowing electrical current to flow.

The blade (304) is limited in its forward moment because of its contact (400) touching the contact (404) of the switch (406). However, the surround (302) of the invention (300) is able to still move relative to the blade. The range of movement of the surround is determined by the distance between the top and bottom of the slot (not visible in this view but identified as 312 in FIG. 3A). To cease flow of the electrical current, a force can be applied to this surround such that it moves upwards, away from the contact of the switch.

As some initial movement of the surround (302) is allowed, this allows it to accelerate before the lower side of the slot (312 in FIG. 3A) touches the extreme side edges (316) of the blade (304). The force of this impact is sufficient to break the contacts (400, 404) apart, thereby opening the switch (406).

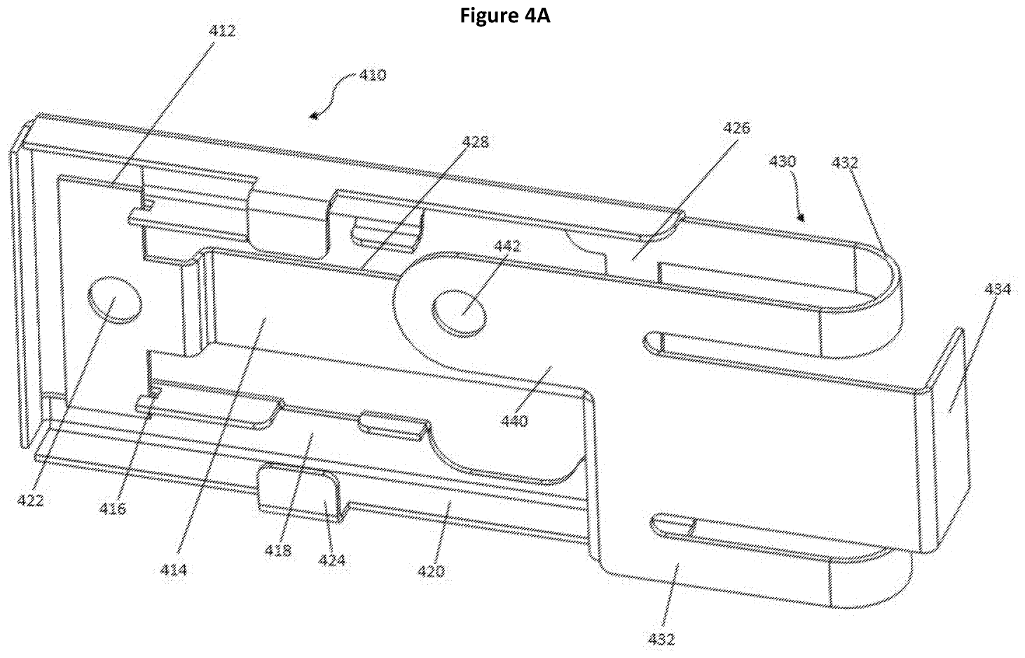

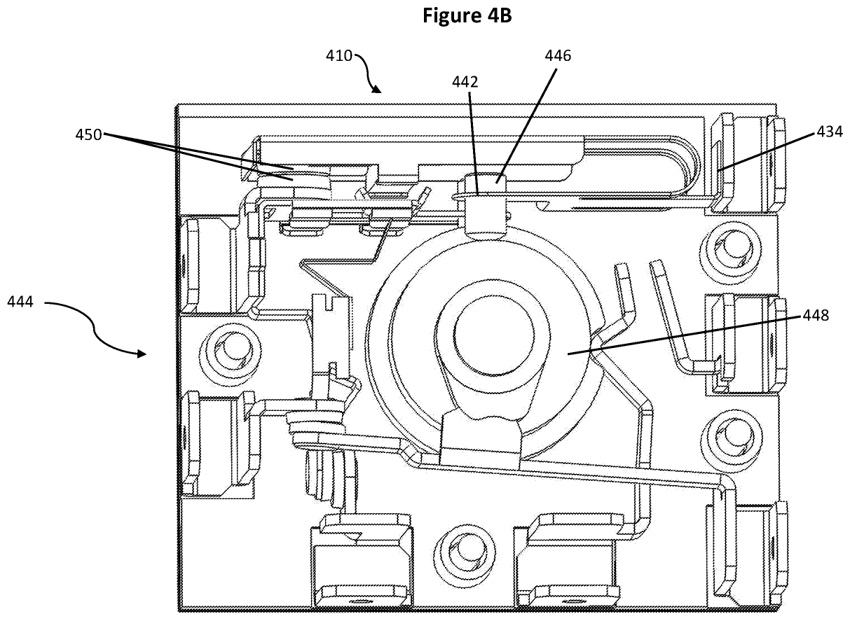

A further alternative embodiment (410) of the present invention is illustrated in FIG. 4A. It can be seen from this Figure that the head (412) of the blade (414) has its range of movement limited by notches (416) formed in protrusions (418) extending inwardly from the flange (420). These notches function in a similar manner to the slots (312) of the previous embodiment(s), however the use of notches, may provide advantages during manufacture and/or assembly of the switching blade.

While the notches (416) are provided on separate protrusions (418) extending inwardly from the flange (420), a person skilled in the art will appreciate that the notches may be provided directly to the flange (420).

Similar to the previous embodiments the head (412) of the switching blade (414) includes an aperture (422) configured to support an electrical contact (not shown).

Compartments (424) are provided, which may in-use support a magnet or a ferromagnetic material. This magnet is used to attract the blade (414), its head (412) and the surround (426) together in a forward direction, overcoming the sprung bias of the blade so that its contact (only aperture 422 into which the contact would be fitted is shown) closes with that of the switch (not shown) to allow electrical current to flow.

It should be appreciated that the compartments (424) configured to support the magnet or ferromagnetic material may be supported by the protrusions directly. Furthermore, the compartments may be configured to extend across a substantial portion of the separation between the two exterior flanges (420).

Furthermore, it will be appreciated that the embodiment of the switching blade depicted in FIG. 4A has a neck portion (428) and surround (426) with a smaller footprint than previous embodiments. This may advantageously reduce the amount of material required, potentially reducing the weight and the cost of the switching blade (410). The material reduction may further impact the inherent biasing or spring force of the switching blade, and therefore it should be appreciated that the relative sizing of these regions may be adjusted as required by the use application.

The biasing/spring force of the switching blade (410) in FIG. 4A has further adjustability provided by the configuration of the distal end (430) of the blade (414). Rather than attaching the distal end of the blade directly to a structure, the present invention provides a plurality of biasing means (432) located between the blade and the attachment point (434). This configuration may advantageously provide for greater deflection of the switching blade, or alternatively allow for greater adjustment of the biasing forces. It should also be appreciated that while a plurality of biasing means are illustrated, this should not be seen as limiting on the invention and modifications to the number, shape, or configurations of the biasing means should be provided within the scope and the spirit of the present disclosure.

The switching blade (410) of FIG. 4A further comprises an adjustment arm (440) which allows the effective biasing force provided by the biasing means (432) to be adjusted in-use. This adjustment may allow for any manufacturing variation to be accounted for and additionally may enable the present switching blade to be suitable for use in a wider range of applications.

The adjustment arm preferably further comprises a threaded aperture (442). This threaded aperture may be used to accommodate a threaded adjustment member (not pictured) such as a set screw or grub screw. It will be appreciated by those skilled in the art however that other adjustment means fall within the spirit and the scope of the present disclosure, and that engagement with a threaded aperture is provided as an exemplary embodiment of a preferred method of adjustment.

The adjustment of the biasing means is better illustrated in FIG. 4B which shows the switching blade (410) of the present invention in-use as part of an energy regulator (444) such as a stovetop temperature adjustment.

As shown in FIG. 4B, the threaded aperture (442) is provided with a threaded adjustment member (446) in the form of a set/grub screw. This adjustment device acts upon a cam (448), such that rotation of the cam may adjust the biasing force applied to the switching blade (410). In this way energy regulation, may be achieved.

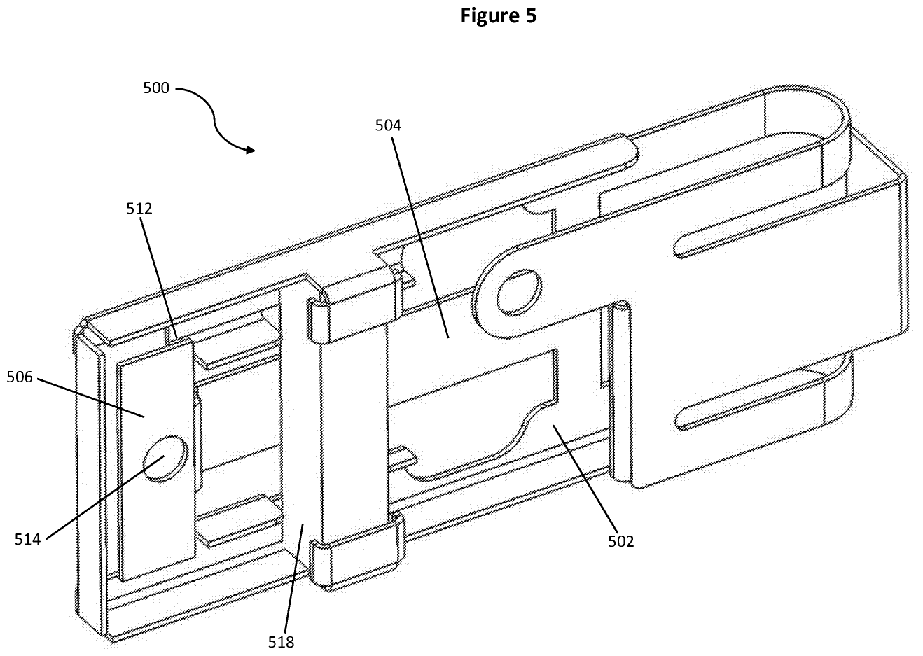

Referring now to FIG. 5, in this embodiment of the switching blade (500), the head (506) of the blade (504) has a limited range of motion vertically due to the interfering members/shoulders (512) above the head of the blade. It can also be seen from this embodiment that the magnet (518) may provide a limitation to the range of movement of the head of the blade in an opposing direction.

For example, adjustment of the cam (448) may decrease the biasing force of the switching blade (410) reducing the force which opposes the mating of the electrical contacts (450) This tends to close the contacts resulting in electrical current flow. Conversely the cam may increase the biasing force, thereby increasing the force opposing the mating of the electrical contacts and encouraging separation of the aforementioned contacts.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the present invention have been described by way of example only and it should be appreciated that modifications and additions may be made thereto without departing from the scope thereof.

1-41. (canceled)

42. A switching blade for an electrical switch, the switching blade comprising:
a surround;
an attachment point; and
a blade which includes a head, the head carrying an electrical contact,
wherein the blade is configured to move between a first position and a second position, wherein in the first position, the head of the blade is spaced apart from and able to move relative to the surround, and in the second position the blade abuts an interfering member such that the head of the blade and the surround are able to move in unison relative to the attachment point.

43. The switching blade as claimed in claim 42, wherein the blade and the surround have a unitary construction.

44. The switching blade as claimed in claim 42, wherein the switching blade is formed from a substantially flat blank material.

45. The switching blade as claimed in claim 44, wherein the blank material is a metal.

46. The switching blade as claimed in claim 45, wherein the blank material is comprised from one or more of: stainless steel; copper; INVAR; brass; or a bi-metallic combination of metals.

47. The switching blade as claimed in claim 46, wherein the electrical contact comprises copper or silver.

48. The switching blade as claimed in claim 42, wherein the blade further comprises a neck which connects the head to the surround.

49. The switching blade as claimed in claim 48, wherein the neck comprises a bend or kink which displaces the head of the blade relative to the surround.

50. The switching blade as claimed in claim 42, wherein the surround comprises a bend or kink which displaces a portion of the surround relative to the head of the blade.

51. The switching blade as claimed in claim 42, wherein the interfering member is formed in the surround.

52. The switching blade as claimed in claim 42, wherein the surround further comprises a flange and/or a portion configured to receive a magnet.

53. The switching blade as claimed in claim 52, wherein the interfering member is:
a) formed in the flange; or
b) the magnet, or the portion configured to receive the magnet.

54. The switching blade as claimed in claim 42, wherein the head of the blade abuts the interfering member in the second position.

55. An electrical switch, comprising:
a housing; and
a switching blade, the switching blade including:
a surround;
an attachment point; and
a blade which includes a head, the head carrying an electrical contact,
wherein the blade is configured to move between a first position and a second position, wherein in the first position, the head of the blade is spaced apart from and able to move relative to the surround, and in the second position the blade abuts an interfering member such that the head of the blade and the surround are able to move in unison relative to the attachment point.

56. The electrical switch as claimed in claim 55, wherein at least a portion of the switching blade is fixed relative to the housing.

57. The electrical switch as claimed in claim 55, wherein the electrical switch comprises at least one mating contact mounted to a portion of the housing.

58. The electrical switch as claimed in claim 55, wherein the surround: further comprises a flange and/or a portion configured to receive a magnet.

59. The electrical switch as claimed in claim 58, wherein the interfering member is:
a) formed in the flange; or
b) the magnet, or the portion configured to receive the magnet.

60. The electrical switch as claimed in claim 55, wherein the housing further comprises a portion configured to receive a magnet.

61. The electrical switch as claimed in claim 55, wherein the head of the blade abuts the interfering member in the second position.
